(19) United States
(12) Patent Application Publication
(10) Pub. No.: US 2014/0212702 A1
(43) Pub. Date: Jul. 31, 2014

(54) BATTERY PACK

(71) Applicant: Samsung SDI Co., Ltd., Yongin-si (KR)

(72) Inventors: Jong-Hwa Hur, Yongin-si (KR); Sang-Do Heo, Yongin-si (KR)

(73) Assignee: Samsung SDI Co., Ltd., Yongin-si (KR)

(21) Appl. No.: 14/167,569

(22) Filed: Jan. 29, 2014

(30) Foreign Application Priority Data
Jan. 31, 2013 (KR) 10-2013-0011085

(51) Int. Cl. H01M 10/42

(52) U.S. Cl. CPC H01M 10/4257
USPC 429/7

(57) ABSTRACT

A battery pack includes an electrode assembly, a lower case and an upper case. The electrode assembly has first and second electrode tabs. The lower case has an opening, and accommodates the electrode assembly so that the first and second electrode tabs face the opening. The upper case includes a protective circuit module and a molding portion integrally injection-molded with the protective circuit module, and seals the opening. In the battery pack, the protective circuit module has first and second terminals directly connected to the respective first and second electrode tabs.

### CROSS-REFERENCE TO RELATED APPLICATIONS

This application claims priority to and the benefit of Korean Patent Application No. 10-2013-0011085, filed on Jan. 31, 2013, in the Korean Intellectual Property Office, the entire content of which is incorporated herein by reference.

### BACKGROUND OF THE INVENTION

1. Field of the Invention

An aspect of the present invention relates to a battery pack, and more particularly, to a battery pack having a new structure.

2. Description of the Related Art

Recently, secondary batteries have been variously used as power sources of portable electronic devices. As the portable electronic devices are used in various fields, demands on secondary batteries have rapidly increased. The secondary batteries can be charged/discharged a plurality of times, and accordingly are economically and environmentally efficient. Thus, the use of the battery packs is encouraged.

As the small size and light weight of electronic devices are required, the small size and light weight of battery packs are also required. However, since a material such as lithium having high reactivity is provided to the inside of a battery pack, the small size and light weight of the secondary battery is limited due to the safety of the battery pack. Accordingly, a variety of studies have been conducted to develop a battery pack that is smaller in size and lighter in weight while improving the safety of the battery pack.

### SUMMARY OF THE INVENTION

Embodiments provide a battery pack that becomes light in weight and small in size by simplifying the structure thereof.

Embodiments also provide a battery pack provided with an upper case having a new structure by omitting a cap assembly.

According to an aspect of the present invention, there is provided a battery pack, including: an electrode assembly having first and second electrode tabs; a lower case having an opening, and accommodating the electrode assembly so that the first and second electrode tabs face the opening; and an upper case including a protective circuit module and a molding portion integrally injection-molded with the protective circuit module, and sealing the opening, wherein the protective circuit module has first and second terminals directly connected to the respective first and second electrode tabs.

The protective circuit module may include a lower surface facing the opening of the lower case and an upper surface that is a surface opposite to the lower surface, and an external terminal portion may be provided to the upper surface.

One or more welding portions having the first and second terminals welded thereto may be provided to the lower surface of the protective circuit module.

An insulation member extended to the molding portion may be further provided on the welding portion.

One or more openings passing through the upper and lower surfaces of the protective circuit module may be provided in the protective circuit module, and the first or second terminal may be provided to pass through the opening.

The protective circuit module may have a surface roughness provided to the opening, and the surface roughness may be provided to contact the first or second terminal passing through the opening.

One or more welding portions having the first or second terminal welded thereto may be provided to the upper surface of the protective circuit module, and the welding portion may be provided adjacent to the opening.

The first or second terminal may be connected to the welding portion by passing through the opening and then bent at the opening.

The welding portion may be provided to have a height lower than that of a peripheral portion thereof.

The opening may be provided to extend to the welding portion.

The thickness of the first or second terminal welded to the welding portion may be provided smaller than the difference in height between the welding portion and the peripheral portion.

The battery pack may further include a label covering side surfaces of the lower case and at least one portion of the upper case.

The lower case may include a can made of aluminum or iron.

The upper and lower cases may be coupled through thermal fusion.

The at least one portion of the upper case may be inserted into the opening of the lower case.

The molding portion may include first and second base portions respectively provided to cover upper and lower portions of the protective circuit module, and a side portion covering side surfaces of the protective circuit module and connecting outer circumferences of the first and second base portions to each other.

A first fastening portion may be provided to an outer surface of the side portion, and the lower case may have a second fastening portion fastened to the first fastening portion.

As described above, according to the present invention, it is possible to provide a battery pack that becomes light in weight and small in size by simplifying the structure thereof.

Further, it is possible to provide a battery pack provided with an upper case having a new structure by omitting a cap assembly.

In another aspect, the present invention comprises a battery pack comprising a case that defines a space and has an opening that provides access to the space; an electrode assembly that is positioned within the case; a protection circuit board assembly that comprises an a protection circuit board that is positioned within a plastic casing, wherein the plastic casing is sized so as to fit within the opening of the case to secure the electrode assembly within the case, wherein the electrode assembly includes first and second terminals that connect with the protection circuit board.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a battery pack according to an embodiment of the present invention.

FIG. 2 is an exploded perspective view of battery pack shown in FIG. 1.

FIG. 3 is a sectional view taken along line I-I of FIG. 2.

FIG. 4A is a top perspective view of a protective circuit module according to an embodiment of the present invention.

FIG. 4B is a bottom perspective view of the protective circuit module according to the embodiment of the present invention.

FIG. 5 is a perspective view of a protective circuit module according to another embodiment of the present invention.

FIG. 6 is an exploded perspective view of the protective circuit module shown in FIG. 5.

FIG. 7 is an exploded perspective view of a protective circuit module according to still another embodiment of the present invention.

FIG. 8A is a sectional view taken along line II-II of FIG. 7.

FIG. 8B is a sectional view schematically showing a state in which a first terminal is provided to a welding portion of FIG. 7.

### DETAILED DESCRIPTION OF THE PREFERRED EMBODIMENT

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

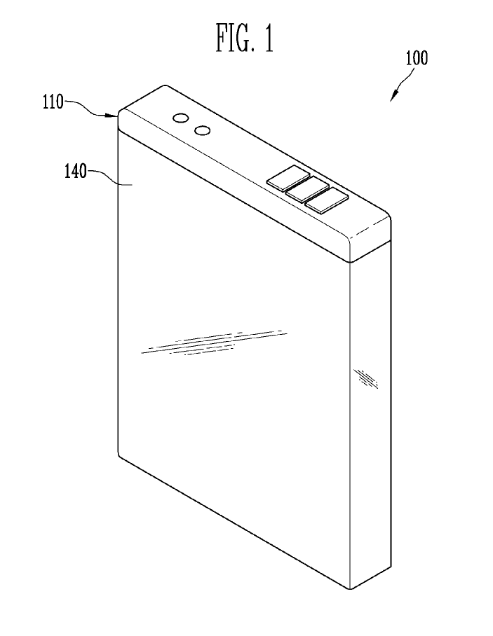

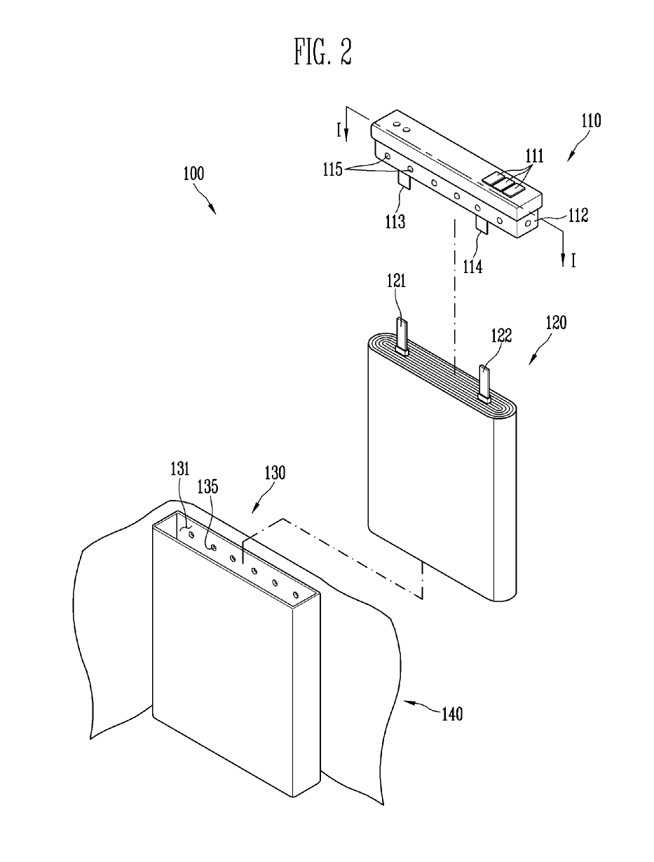

FIG. 1 is a perspective view of a battery pack according to an embodiment of the present invention. FIG. 2 is an exploded perspective view of battery pack shown in FIG. 1.

The battery pack 100 according to this embodiment includes an electrode assembly 120 having first and second electrode tabs 121 and 122; a lower case 130 having an opened first surface or opening 131, and accommodating the electrode assembly 120 so that the first and second electrode tabs 121 and 122 face and extend out of the first open surface 131; and an upper case 110 including a protective circuit module and a molding portion 112 integrally injection molded with the protective circuit module which seals the opening 131. The protective circuit module may have first and second terminals 113 and 114 directly connected to the respective first and second electrode tabs 121 and 122.

The electrode assembly 120 may be manufactured by various methods including a method of winding or stacking positive and negative electrode plates respectively provided with the first and second electrode tabs 121 and 122, and a separator interposed between the positive and negative electrode plates. Electrochemical energy generated in the electrode assembly 120 may be transmitted to the outside of the battery pack 100 through the first and second electrode tabs 121 and 122.

The lower case 130 has the opening 131, so as to accommodate the electrode assembly 120 and an electrolyte therein. The electrode assembly 120 may be accommodated in the lower case 130 so that the first and second electrode tabs 121 and 122 face the opening 131. For example, the lower case 130 may include a can made of aluminum or iron.

At least one portion of the upper case 110 may be inserted into the Opening 131 of the lower case 130, so as to seal the opening 131. In this case, the upper case 110 may have a first fastening portion 115 provided at the portion inserted into the opening, and the lower case may have a second fastening portion 135 fastened to the first fastening portion 115. For example, the first and second fastening portions 115 and 135 may be fastened to each other by a groove-projection connection or surface roughness connection.

Alternatively, the upper and lower cases 110 and 130 may be coupled to each other through thermal fusion. The opening 131 may be sealed by forcibly inserting the upper case 110 into the opening 131 of the lower case 130 and then heating the upper and lower cases 110 and 130 so that the upper and lower cases 110 and 130 are thermally fused. In this case, the fastening force between the upper and lower cases 110 and 130 can be improved by pressurizing an outer surface of the lower case 130, which contacts the upper case 110.

The battery pack 100 may further include a label 140 covering the side surface of the lower case 130 and at least one portion of the upper case 110. For example, the label 140 may be formed as an insulation sheet having an adhesive member provided on one surface thereof. The label 140 allows the upper and lower cases 110 and 130 to be fixed together, so that the upper case 110 can be firmly fixed to the lower case 130.

FIG. 3 is a sectional view taken along line I-I of FIG. 2.

Referring to FIG. 3, in the upper case 110, the protective circuit module 150 and the molding portion 112 may be integrally formed, and the molding portion 112 may be injection-molded to surround the outer surface of the protective circuit module 150. The molding portion 112 may include first and second base portions 112a and 112b respectively provided to cover upper and lower portions of the protective circuit module 150, and a side portion 112c covering side surfaces of the protective circuit module 150 and connecting the outer circumferences of the first and second base portions 112a and 112b. In this case, the first fastening portion 115 is provided to the outer surface of the side portion 112c, so as to be fastened to the second fastening portion 135 of the lower case 130. The first and second terminals 113 and 114 may be provided to the protective circuit module 150. In this case, the first and second terminals 113 and 114 may be provided to protrude outward from the molding portion 112. The first and second terminals 113 and 114 may be made of a conductive material such as metal. For example, the first and second terminals 113 and 114 may be made of any one or more of nickel, aluminum, copper and the like.

Generally, a battery pack is manufactured by accommodating an electrode assembly in a lower case which can be represented as a can and then sealing the lower case with a cap assembly having a negative electrode pin, a vent and the like. In this case, first and second electrode tabs provided to the electrode assembly are connected to the cap assembly. Subsequently, a separate protective circuit module is provided at an upper portion of the cap assembly, and a top cover made of an insulator is additionally provided to protect the protective circuit module. That is, the cap assembly, the protective circuit module and the top cover are sequentially provided on the top of the lower case. The cap assembly, the protective circuit module and the top cover are spaced apart from one another at a certain interval for the purpose of electrical or physical connection, and therefore, the volume of the battery pack is increased. Further, each of the cap assembly, the protective circuit module and the top cover requires a complicated process, and therefore, processing time is increased. Accordingly, a failure of the battery pack frequently occurs.

On the other hand, the battery pack according to this embodiment may be formed by coupling the lower and upper cases to each other. In this case, a separate cap assembly is not required. That is, the protective circuit module and the molding portion are integrally formed in the upper case, and the protective circuit module is directly connected to the first and second electrode tabs of the electrode assembly by the first and second terminals. Thus, the manufacturing process of the battery pack can be simplified, and the volume of the battery pack can be decreased. Accordingly, the capacity of the battery pack per unit volume can be increased.

The upper case 110 according to this embodiment is insert-injection-molded by inserting the protective circuit module 150 into a mold and then injecting resin or the like melted in the mold. The molding portion 112 made of the resin or the like and the protective circuit module 150 may be integrally formed. In this case, the molding portion 112 may be provided so that at least one portion of the protective circuit module 150 is exposed.

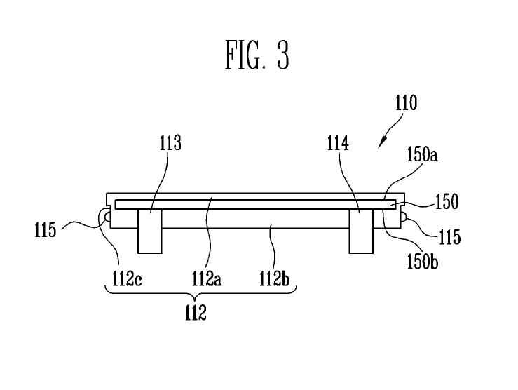

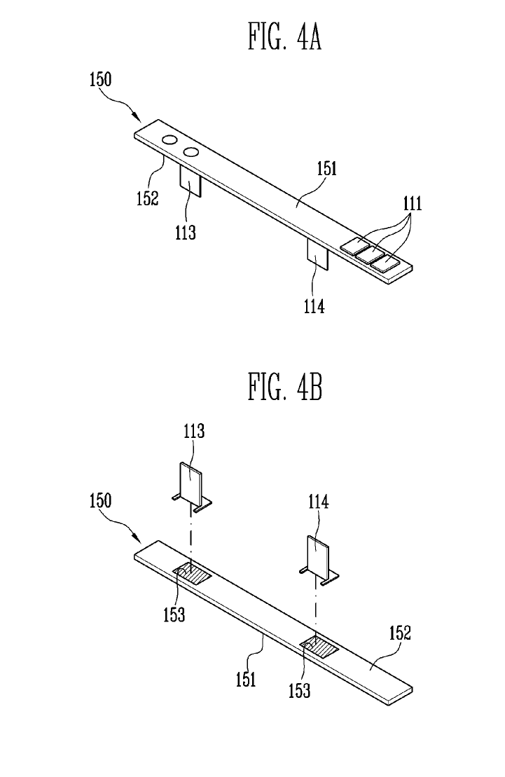

FIG. 4A is a top perspective view of a protective circuit module according to an embodiment of the present invention. FIG. 4B is a bottom perspective view of the protective circuit module according to the embodiment of the present invention.

Referring to FIGS. 4A and 4B, the protective circuit module 150 includes a lower surface 152 facing the opening of the lower case and an upper surface 151 that is a surface opposite to the lower surface 152. An external terminal portion 111 may be provided to the upper surface 151. The external terminal portion 111 is electrically connected to an external electronic device using the battery pack as a power source, so that current can flow in the external electronic device.

The protective circuit module 150 may have first and second terminals 113 and 114 directly connected to the respective first and second electrode tabs of the electrode assembly through welding or the like. One or more welding portions 153 at which the first and second terminals 113 and 114 are welded to the protective circuit module 150 may be provided to the lower surface 152 of the protective circuit module 150. A plurality of electronic elements are mounted in the protective circuit module 150, and may be electrically connected to one another by a circuit pattern. The welding portions 153 may be connected to the circuit pattern of the protective circuit module 150. The welding portions 153 may be electrically connected to the electrode assembly through the first and second terminals 113 and 114 and the first and second electrode tabs. Although it has been illustrated in FIG. 4B that the first or second terminal 113 or 114 is directly connected to the welding portion 153 of the protective circuit module 150, a secondary protection element or the like may be interposed between the welding portion 153 and the first or second terminal 113 or 114.

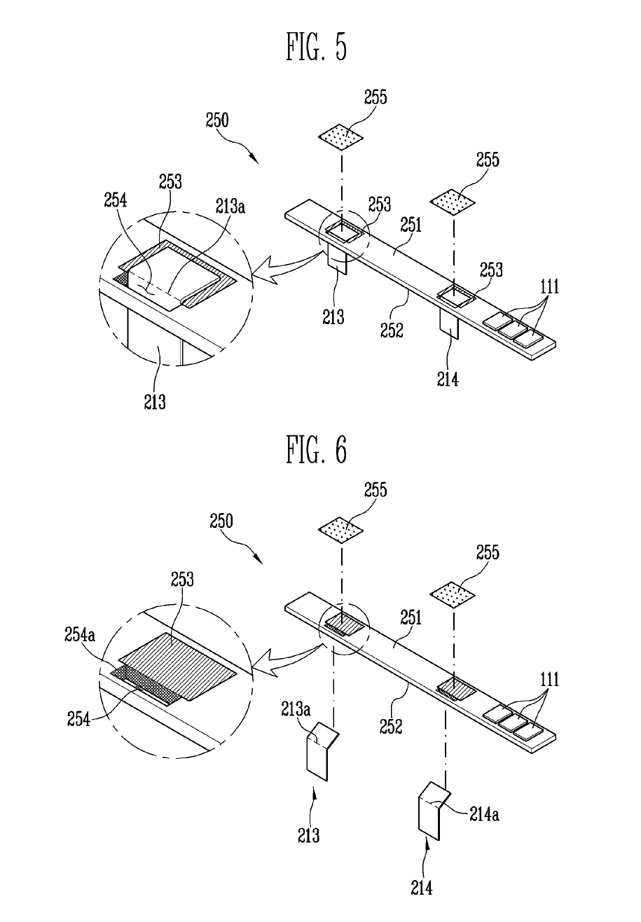

Hereinafter, another embodiment of the present invention will be described with reference to FIGS. 5 and 6. Contents of these embodiments, except the following contents, are similar to those of the embodiment described with reference to FIGS. 1 to 4B, and therefore, their detailed descriptions will be omitted.

FIG. 5 is a perspective view of a protective circuit module according to another embodiment of the present invention. FIG. 6 is an exploded perspective view of the protective circuit module shown in FIG. 5.

FIGS. 5 and 6 are perspective views of a protective circuit module 250 included in the upper case of the battery pack according to another embodiment of the present invention. The protective circuit module 250 according to this embodiment is integrally formed with the molding portion, and first and second terminals 213 and 214 provided to the protective circuit module 250 are protruded outward from the molding portion, so as to be directly connected to the respective first and second electrode tabs of the electrode assembly. The upper case is coupled to the lower case accommodating the electrode assembly therein, so as to directly seal the opening of the lower case.

The protective circuit module 250 according to this embodiment is provided with one or more openings 254 passing through upper and lower surfaces 251 and 252 thereof, and the first or second terminal 213 or 214 may be provided to pass through the opening 254. An external terminal portion 111 electrically connected to an external electronic device is provided to the upper surface 251 of the protective circuit module 250, and the lower surface 252 of the protective circuit module 250 may be opposite to the electrode assembly. One or more welding portions 253 at which the first or second terminal 213 or 214 is welded to the protective circuit module 250 are provided to the upper surface 251 of the protective circuit module 250. The welding portion 253 may be provided adjacent to the opening 254.

The first or second terminal 213 or 214 is connected to the welding portion 253 by passing through the opening 254, and may be bent at the opening 254. Bending portions 213a and 214a may be provided to the first and second terminals 213 and 214, respectively. For example, the bending portion 213a or 214a may be provided by concavely forming a groove in the first or second terminal 213 or 214 using a knife or the like. The bending portion 213a or 214a may be provided before the first or second terminal 213 or 214 passes through the opening. Thus, after the first or second terminal 213 or 214 passes through the opening 254, the bending portion 213a or 214a guides the bending position of the first or second terminal 213 or 214, thereby facilitating the bending of the first or second terminal 213 or 214. The position at which the first or second terminal 213 or 214 is bent by the bending portion 213a or 214a is previously determined, and thus it is possible to facilitate the coupling between the welding portion 253 and the first or second terminal 213 or 214.

In the protective circuit module 250, a surface roughness 254a may be provided to the opening 254. For example, the surface roughness 254a may be provided to the side surface defining the opening 254 in the protective circuit module 250, so that the first or second terminal 213 or 214 passing through the opening 254 contacts the surface roughness 254a. The surface roughness 254a may be provided to have a rough surface so that the frictional force of the surface roughness 254a is increased. The opening 253 may be provided greater than the first or second terminal 213 or 214, in consideration of assembling tolerance, so that the first or second terminal 213 or 214 can be easily inserted into the opening 253. The first or second terminal 213 or 214 may be made of a conductive material having a smooth surface, such as metal. The first or second terminal 213 or 214 may be moved after being inserted into the opening 254. In this case, the surface roughness 254a can prevent the movement of the first or second terminal 213 or 214 by means of the frictional force. Thus, it is possible to facilitate the connection between the welding portion 253 and the first or second terminal 213 or 214 and the connection between the first or second terminal 213 or 214 and the first or second electrode tab.

An insulation member 255 extended to the molding portion may be further provided on the welding portion 253. The protective circuit module 250 configured in this embodiment may be integrally injection-molded with the molding portion. In this case, the molding portion may not be provided to the welding portion so that the first or second terminal 213 or 124 is exposed. Thus, after the first or second terminal 213 or 214 is connected to the welding portion 253, the insulation member 255 is provided, so that it is possible to reinforce the connection between the welding portion 253 and the first or second terminal 213 or 124 and to improve insulation properties. For example, the insulation member 255 may be made of the same resin as the molding portion or may include silicon.

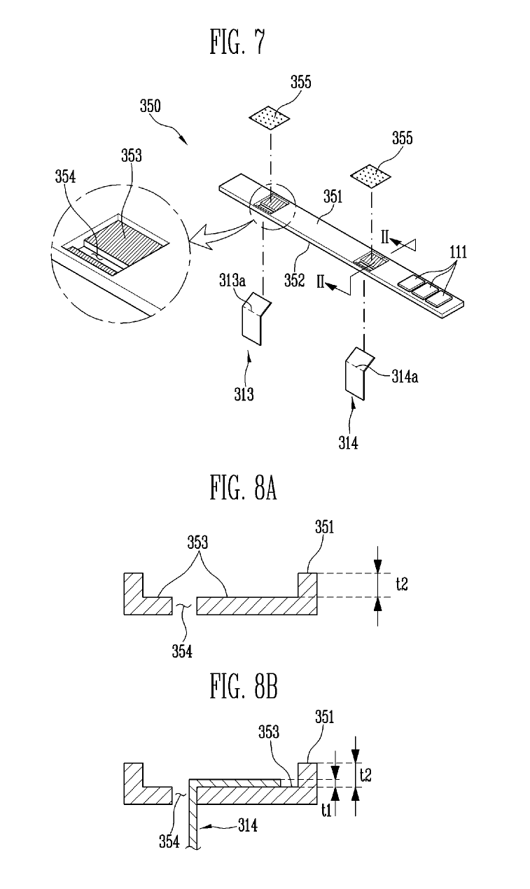

FIG. 7 is an exploded perspective view of a protective circuit module according to still another embodiment of the present invention. FIG. 8A is a sectional view taken along line II-II of FIG. 7. FIG. 8B is a sectional view schematically showing a state in which a first terminal is provided to a welding portion of FIG. 7.

The protective circuit module 350 according to this embodiment may be injection-molded to be integrally formed with the molding portion, thereby manufacturing an upper case. The upper case seals the opening of the lower case having the electrode assembly accommodated therein. First and second terminals 313 and 314 provided to the protective circuit module 350 may be directly connected to the respective first and second electrode tabs of the electrode assembly.

The protective circuit module 350 may include an upper surface 351 having an external terminal portion 111 provided thereto, and a lower surface 352 facing the first surface as a surface opposite to the upper surface 351. One or more openings 354 through which the first or second terminal 313 or 314 passes may be provided in the protective circuit module 350. The first or second terminal 313 or 314 is inserted into the opening 354, and may be bent at a bending portion 313a or 314a provided to the first or second terminal 313 or 314. In this case, the bending portion 313a or 314a may be provided to contact a corner of the opening 354.

A welding portion 353 connected to the first or second terminal 313 or 314 while being spaced apart from the external terminal portion 111 may be provided to the upper surface 351 of the protective circuit module 350. In this case, the welding portion 353 may be provided to have a height lower than that of a peripheral portion thereof. For example, the welding portion 353 may be provided to be recessed inward from the upper surface 351 of the protective circuit module 350, and the opening 354 may be provided to extend to the welding portion 353.

The first or second terminal 313 or 314 is inserted into the opening 354 and then bent. The first or second terminal 313 or 314 may be connected to the welding portion 353 through welding or the like. Since the welding portion 353 is provided to have the height lower than that of the peripheral portion thereof, the first or second terminal 313 or 314 may be fixed in a space formed by the welding portion 353. Thus, it is possible to easily guide the position of the first or second terminal 313 or 314.

The thickness t1 of the first or second terminal 313 or 314 welded to the welding portion 353 may be provided smaller than the difference in height between the welding portion 353 and the peripheral portion. Thus, after the first or second terminal 313 or 314 is welded to the welding portion 353, the upper surface 351 of the protective circuit module 350 is not protruded but can be provided as an approximately flat surface. After the first or second terminal 313 or 314 is welded to the welding portion 353, an insulation member 355 may be further provided on the welding portion 353.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack, comprising:
an electrode assembly having first and second electrode tabs;
a lower case having an opening, and accommodating the electrode assembly so that the first and second electrode tabs face the opening; and
an upper case including a protective circuit module and a molding portion integrally injection-molded with the protective circuit module, and sealing the opening,
wherein the protective circuit module has first and second terminals directly connected to the respective first and second electrode tabs.

2. The battery pack of claim 1, wherein the protective circuit module includes a lower surface facing the opening of the lower case and an upper surface that is a surface opposite to the lower surface, and an external terminal portion is provided to the upper surface.

3. The battery pack of claim 2, wherein one or more welding portions having the first and second terminals welded thereto are provided to the lower surface of the protective circuit module.

4. The battery pack of claim 3, wherein an insulation member extended to the molding portion is further provided on the one or more welding portions.

5. The battery pack of claim 2, wherein one or more openings passing through the upper and lower surfaces of the protective circuit module are provided in the protective circuit module, and the first or second terminal is provided to pass through the opening.

6. The battery pack of claim 5, wherein the protective circuit module has a surface roughness provided to the opening, and the surface roughness is provided to contact the first or second terminal passing through the opening.

7. The battery pack of claim 5, wherein one or more welding portions having the first or second terminal welded thereto are provided to the upper surface of the protective circuit module, and the welding portion is provided adjacent to the opening.

8. The battery pack of claim 7, wherein the first or second terminal is connected to the welding portion by passing through the opening and then bent at the opening.

9. The battery pack of claim 7, wherein the welding portion is provided to have a height lower than that of a peripheral portion thereof.

10. The battery pack of claim 9, wherein the opening is provided to extend to the welding portion.

11. The battery pack of claim 9, wherein the thickness of the first or second terminal welded to the welding portion is provided smaller than the difference in height between the welding portion and the peripheral portion.

12. The battery pack of claim 1, further comprising a label covering side surfaces of the lower case and at least one portion of the upper case.

13. The battery pack of claim 1, wherein the lower case includes a can made of aluminum or iron.

14. The battery pack of claim 1, wherein the upper and lower cases are coupled through thermal fusion.

15. The battery pack of claim 1, wherein the at least one portion of the upper case is inserted into the opening of the lower case.

16. The battery pack of claim 15, wherein the molding portion includes first and second base portions respectively provided to cover upper and lower portions of the protective circuit module, and a side portion covering side surfaces of the protective circuit module and connecting outer circumferences of the first and second base portions to each other.

17. The battery pack of claim 16, wherein a first fastening portion is provided to an outer surface of the side portion, and the lower case has a second fastening portion fastened to the first fastening portion.

18. A battery pack comprising:
a case that defines a space and has an opening that provides access to the space;
an electrode assembly that is positioned within the case; and
a protection circuit board assembly that comprises an a protection circuit board that is positioned within a plastic casing, wherein the plastic casing is sized so as to fit within the opening of the case to secure the electrode assembly within the case, wherein the electrode assembly includes first and second terminals that connect with the protection circuit board.

19. The battery pack of claim 18, wherein the protection circuit board assembly has a first surface that is positioned within the opening in the electrode assembly and a second surface and wherein at least one opening is formed to permit a terminal to extend through the protection circuit board assembly so that the terminal is connected to the protection circuit board adjacent the second surface of the protection circuit board assembly.

20. The battery pack of claim 19, wherein the terminal is bent so that a horizontally extending section of the terminal is welded to the second surface of the protection circuit board assembly.
